(19) United States
(12) Patent Application Publication
(10) Pub. No.: US 2025/0369235 A1
(43) Pub. Date: Dec. 4, 2025

(54) FLOOR TILE

(71) Applicant: KKVV GMBH, BOTTROP (DE)

(72) Inventor: ANDREAS KOCZWARA, BOTTROP (DE)

(73) Assignee: KKVV GMBH, BOTTROP (DE)

(21) Appl. No.: 19/215,360

(22) Filed: May 22, 2025

(30) Foreign Application Priority Data
May 28, 2024 (DE) 20 2024 102 762.0
Jan. 10, 2025 (EP) 25151098.8

(51) Int. Cl. E04F 15/02

(52) U.S. Cl. CPC E04F 15/02038; E04F 2201/043

(57) ABSTRACT

A floor tile includes a main body which is arranged to be flat. The main body has, at at least two opposite edges, a tongue-and-groove joint which is interlockable and which is integrally joined to the main body. The main body is fired.

### CROSS REFERENCE TO PRIOR APPLICATIONS

Priority is claimed to German Utility Patent Application No. DE 20 2024 102 762.0, filed May 28, 2024, and to European Patent Application No. 25151098.8, filed Jan. 10, 2025. The entire disclosure of said applications are incorporated by reference herein.

### FIELD

The present invention relates to a floor tile.

### BACKGROUND

Floor tiles are popular and robust floor coverings. Floor tiles are often more likely to be laid than, for example, parquet or laminate, in particular in entrance areas, kitchens, or bathrooms. The popularity of floor tiles in the areas mentioned is a function of their structural properties, i.e., floor tiles are robust and easy to clean. Consumers have also become accustomed to floor tiles being laid in rooms where a high probability exists of water and dirt coming into contact with the floor.

In addition to these reasons for the popularity of floor tiles, it is in particular also haptics which make other floor coverings appear less suitable for laying in some rooms. Consumers expect the feeling of floor tiles from the floor in an entrance area. This floor should appear stable and provide an impression of solid stone.

Building infrastructure often also plays a role in the selection of a floor covering. If, for example, underfloor heating is intended, floor tiles provide considerable advantages over parquet or laminate floors due to their relatively high thermal conductivity.

Aside from all these advantages, a tiled floor also has disadvantages. Compared to the laying of a parquet, laminate or vinyl floor, classical floor tiles are costly and inconvenient to lay. Laying is associated with a great deal of mess, is time-consuming, and costly. In most cases, the consumer leaves the laying of floor tiles to a firm of tradespeople, while modern parquet, laminate, or vinyl floors can readily be laid by a non-expert. Floors made of classical floor tiles must also not be walked on for a period of time after laying and grouting. The removal of classical floor tiles is associated with a great deal of cost, inconvenience, work, and mess, which is likewise undesirable.

### SUMMARY

An aspect of the present invention is to provide a floor tile which does not have the disadvantages of the prior art but is rather also suitable for easy laying by non-experts not having any particular prior knowledge and which may be walked on directly after laying.

In an embodiment, the present invention provides a floor tile which includes a main body which is arranged to be flat. The main body comprises, at at least two opposite edges, a tongue-and-groove joint which is configured to be interlockable and which is integrally joined to the main body. The main body is fired.

### BRIEF DESCRIPTION OF THE DRAWINGS

The present invention is described in greater detail below on the basis of embodiments and of the drawings in which:

FIG. 1 shows a schematic view of a floor tile according to an exemplary embodiment of the present invention;

FIG. 2 shows a sectional schematic view of two floor tiles according to exemplary embodiments of the present invention; and

FIG. 3 shows a sectional schematic view of two floor tiles according to exemplary embodiments of the present invention with an interlocked tongue-and-groove joint.

### DETAILED DESCRIPTION

The floor tile according to the present invention has a flat main body. The main body of the floor tile is fired. This provides the floor tile with excellent haptics. In order to considerably facilitate the laying of the floor tile to form a tiled floor, at least two opposite edges of the main body are provided with an interlockable tongue-and-groove joint. This advantageously makes it possible, by interlocking the tongue-and-groove joints, to lay a pattern of floor tiles according to the present invention stably and simply to form a tiled floor without requiring any bonding and grouting of the floor tiles. The interlocked tongue-and-groove joint firmly joins the floor tiles. Laying and interlocking may be carried out cleanly and without further aids even by non-experts. The interlockability of the tongue-and-groove joint advantageously provides that the tongue-and-groove joint need not be adhesively bonded. To hold together a plurality of floor tiles, these may be easily interlocked with one another. The interlocking is released if the floor tiles are to be removed.

In the context of the present invention, “firing” is to be understood as meaning a thermally induced binding of individual constituents of the main body and therefore in particular differs from hot extruding, with the result that the structural and haptic properties of fired and hot-extruded materials also differ markedly.

In an embodiment, the present invention provides that the main body can, for example, be fired at at least 100° C. This achieves a particularly stable binding of the constituents of the main body. A firing of the main body at temperatures between 120° C. and 500° C. and in particular between 150° C. and 220° C. is particularly advantageous. This provides a good compromise between strength achieved and energy expended.

In an embodiment, the present invention provides that, to effect interlocking, the tongue-and-groove joint can, for example, be form-fittingly interlinkable. It is in particular provided that the tongue-and-groove joint can be a click joint. This makes it even easier to lay the floor tiles to form a tiled floor, thus allowing even the inexperienced to install a tiled floor.

In an embodiment, the present invention provides that the main body can, for example, comprise mineral constituents, wherein the proportion of the mineral constituents in the main body is at least 50% by weight, for example, at least 75% by weight, in particular more than 90% by weight. This advantageously provides that the main body obtains a strength expected from a floor tile during firing. Typical tile haptics are also achieved through the use of at least 50%, for example, at least 75%, and in particular at least 90%, of mineral constituents. It is conceivable that the mineral constituents comprise quartz. At least half, for example, at least two thirds, and, for example, at least three quarters of the mineral constituents can be quartz. It is in particular provided that the mineral constituents comprise calcium aluminosilicate.

In an embodiment, the present invention provides that the main body can, for example, be fired with a proportion of fibrous material. The fibrous material can, for example, comprise organic fibres and in particular cellulose. The fibrous material contributes significantly to the mechanical suitability of the floor tile as a floor covering and in particular for laying using the interlockable tongue-and-groove joint.

In an embodiment, the present invention provides that the floor tile can, for example, be fired with between 2% by weight and 20% by weight, for example, with between 5% by weight and 18% by weight, and, for example, with between 6% by weight and 15% by weight of fibrous material. The stated ranges are advantageously selected so that the fibrous material does not impair strength and adjusts the mechanics of the main body so that optimal usability of the tongue-and-groove joint is provided.

In an embodiment, the present invention provides that the main body can, for example, not comprise any plastic, in particular no PVC or other polymers. This provides that the floor tile does not pose any health risks. The floor tile in particular does not contain any plasticizers as a result.

In an embodiment, the present invention provides that the main body can, for example, be fired with a proportion of quartz. The quartz of the fired main body thus, for example, undergoes binding. The proportion that has proven optimal is between 10% by weight and 90% by weight of quartz, for example, between 35% by weight and 85% by weight of quartz, and, for example, between 50% by weight and 80% by weight of quartz, and, for example, between 64% by weight and 72% by weight of quartz. The quartz as a mineral constituent gives the floor tile its typical tile properties.

In an embodiment, the present invention provided that the main body can, for example, be fired with between 2% by weight and 40% by weight of calcium aluminosilicate. The main body can, for example, be fired with between 10% by weight and 30% by weight of calcium aluminosilicate. The main body can, for example, be fired with between 20% by weight and 26% by weight of calcium aluminosilicate. The calcium aluminosilicate likewise contributes to the formation of a solid main body during firing of the main body, wherein the described proportions have proven particularly advantageous.

The main body can, for example, comprise tobermorite and can in particular be a tobermorite. The tobermorite can, for example, be formed during the firing of the main body which contributes to the usability of the floor tile and in particular to the introduction of a properly functioning and durable tongue-and-groove joint.

In an embodiment, the present invention provides that the main body can, for example, be chamfered at its edges. It is also conceivable that the main body is pressed at its edges; that, for example, a chamfer is pressed in at the edge of the main body. It is conceivable that the chamfer at the edges of the main body is coloured, for example, lacquered. This makes it possible to arrange a plurality of floor tiles in direct contact with one another without forming a gap between the main bodies. This advantageously increases the structural effect of the laid pattern of floor tiles and simplifies handling since no gap requiring subsequent filling exists.

In an embodiment, the present invention provides that a decorative layer can, for example, be arranged on the main body. The design of the decorative layer may, for example, provide a uniform colouring of the floor tiles. It is conceivable that a wear layer is arranged on the decorative layer and/or that the decorative layer comprises the wear layer. It is also conceivable that the wear layer is arranged directly on the main body, wherein the floor tile does not comprise a decorative layer. The wear layer protects the decorative layer and the main body and provides the opportunity to adapt the surface of the floor tile to the requirements of the user, for example, in terms of optical design, slip resistance, abrasion-resistance class etc. It is conceivable that the decorative layer is printed. It is also conceivable, however, for the decorative layer to comprise a paper layer. It is conceivable for the decorative layer to be a laminate and/or to be laminated to the main body. It is also conceivable for the wear layer to be lacquered, printed, laminated and/or adhesively bonded. The decorative layer and/or the wear layer can, for example, comprise melamine, wherein the proportion of melamine in the floor tile can, for example, be between 0.5% by weight and 5% by weight, for example, between 0.5% by weight and 2% by weight, and, for example, between 1.0% by weight and 1.7% by weight. The melamine impregnates the wear and decorative layer in an advantageous fashion, thus making them more resistant.

In an embodiment, the present invention provides that the floor tile can, for example, comprise a stabilizing layer. The stabilizing layer can, for example, be arranged on the side of the main body opposite to the decorative layer/wear layer. This can prevent unwanted deformation of the floor tile. The stabilizing layer can, for example, comprise melamine for this purpose.

In an embodiment, the present invention provides that the main body can, for example, be printed. The main body can, for example, be printed via digital printing. The printed main body can, for example, be lacquered therefor. This embodiment is particularly advantageous since it is very robust and durable. The print in particular has the result that no stabilizing layer is required. No stabilizing layer need, for example, be arranged on the printed main body.

It is conceivable that production of the main body comprises firing and subsequent cutting. It is in particular provided that the printing and, for example, the lacquering of the main body are performed after cutting. If a decorative layer of paper is applied instead of printing, the present invention provides that the decorative layer of paper can, for example, be applied prior to cutting.

The present invention also provides a process for producing a floor tile. The floor tile can, for example, be a floor tile according to the present invention. A flat main body is fired and an interlockable tongue-and-groove joint is subsequently milled into the main body.

All of the embodiments, advantages and features disclosed in connection with the floor tile according to the present invention likewise relate to the process according to the present invention for producing a floor tile.

Further details, features and advantages of the present invention emerge from the drawings and from the description below of embodiments with reference to the drawings. The drawings thereby merely illustrate exemplary embodiments of the present invention that do not in any way restrict the inventive concept of the present invention.

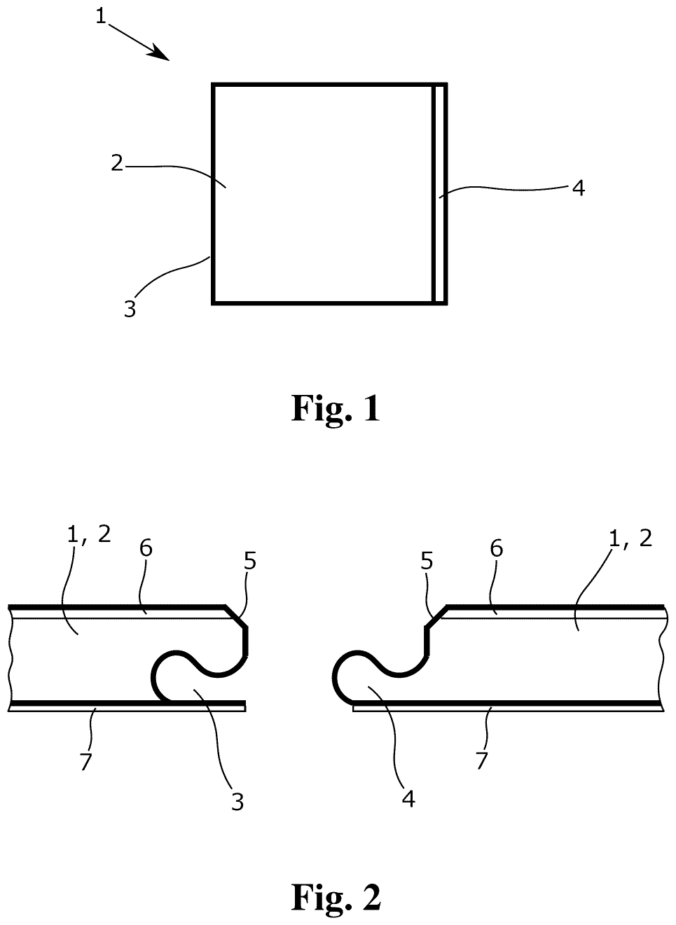

FIG. 1 shows a schematic view of a floor tile 1 according to an exemplary embodiment of the present invention. The floor tile 1 has a main body 2. The main body 2 may be square as shown here. It is also conceivable, however, that the main body 2 may have a different shape, in particular such as rectangular.

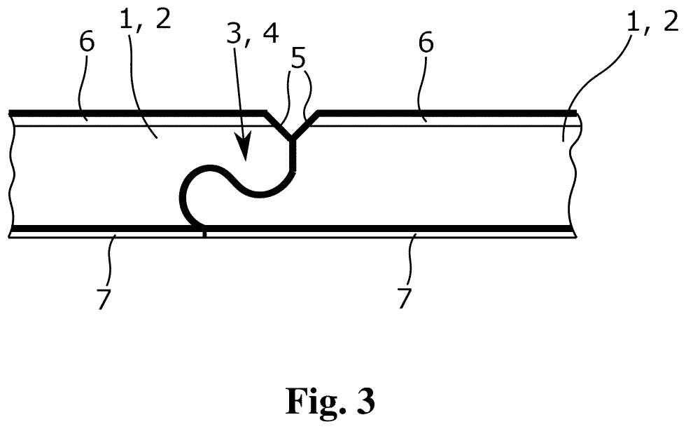

A tongue-and-groove joint 3, 4 is attached at two opposite sides of the main body 2. The tongue-and-groove joint 3, 4 is likewise apparent in the sectional views of FIGS. 2 and 3. It comprises a groove 3 and a tongue 4. The groove 3 is covered in FIG. 1 and is thus not visible. To connect two floor tiles 1, the tongue 4 of a floor tile 1 is introduced into the groove 3 of a further floor tile 1 and form-fittingly interlocked therein. FIG. 3 shows two floor tiles 1 joined this way. The interlockable tongue-and-groove connection forms a click joint. This makes it particularly easy to lay the floor tiles 1 to form a tiled floor.

The edges of the main body 2 are provided here with a chamfer 5. When two or more floor tiles 1 are arranged in a pattern, this results in depressed regions at the abutting edges of the floor tiles 1 which emphasizes the structure of the floor tiles 1 in the pattern. The floor tiles 1 shown are produced as pressed bevel floor coverings; the chamfers 5 are thus pressed into the edges. The floor tiles 1 may alternatively not be chamfered or pressed at the edges so that in the pattern, their sides are practically in contact with one another over their whole surface.

A decorative layer 6 is arranged on the surface of the main body 2. The decorative layer 6 comprises a (not separately shown) wear layer and can thus increase the usability of the floor tile 1 in addition to purely optical effects. The slip resistance or the abrasion-resistance class may thus be adjusted via a corresponding wear layer. The decorative layer 6 may be printed, adhesively bonded, or laminated. The wear layer may likewise be printed, adhesively bonded, or laminated. In the embodiments here shown, the decorative layer 6 is a digital print on which a lacquer layer is applied.

A stabilizing layer 7 is arranged on the surface of the main body 2 opposite to the decorative layer 6. This prevents the floor tile 1 from bending and provides retainment of a uniformly flat shape. The wear, decorative, and stabilizing layer comprise melamine.

The structural properties of the floor tile 1, in particular the strength of the floor tile 1 and the haptics of the floor tile 1, are provided by a particular material composition. The material of the floor tile consists to an extent of 65% by weight to 71% by weight of quartz which is fired at at least 100° C.

In addition to a proportion of 7 to 14% by weight of cellulose and the quartz, the main body 2 of the floor tile 1 is fired with a proportion of 21 to 25% by weight of calcium aluminosilicate. Firing at temperatures between 150° C. and 220° C. causes a tobermorite to be formed in the main body 2. The resulting material is exceptionally suitable for milling of the tongue-and-groove joint 3, 4 into the main body 2. The material mix and the production method result in exactly the right strength required for laying the floor tile 1 using the tongue-and-groove joint 3, 4 in the form of a click joint and providing an exceptional durability of the laid floor tile 1 in everyday use.

The present invention is not limited to embodiments described herein; reference should be had to the appended claims.

### LIST OF REFERENCE NUMERALS

1 Floor tile
2 Main body
3 Groove
4 Tongue
5 Chamfer
6 Decorative layer
7 Stabilizing layer

What is claimed is:

1. A floor tile comprising:
a main body which is arranged to be flat, the main body comprising, at at least two opposite edges, a tongue-and-groove joint which is configured to be interlockable and which is integrally joined to the main body,
wherein the main body is fired.

2. The floor tile as recited in claim 1, wherein the main body is fired at a temperature of at least 100° C.

3. The floor tile as recited in claim 1, wherein, to provide that the tongue-and-groove joint is interlockable, the tongue-and-groove joint is further configured to be form-fittingly interlinkable.

4. The floor tile as recited in claim 3, wherein the tongue-and-groove joint is a click joint.

5. The floor tile as recited in claim 1, wherein the main body further comprises mineral constituents,
wherein,
a proportion of the mineral constituents in the main body is at least 50 wt. %.

6. The floor tile as recited in claim 1, wherein the main body comprises a fibrous material when fired.

7. The floor tile as recited in claim 6, wherein the fibrous material comprises organic fibres.

8. The floor tile as recited in claim 6, wherein the fibrous material is cellulose.

9. The floor tile as recited in claim 6, wherein the floor tile comprises 2 wt. % to 20 wt. % of the fibrous material when fired.

10. The floor tile as recited in claim 1, wherein the main body does not comprise a plastic.

11. The floor tile as recited in claim 1, wherein the main body comprises 10 wt. % to 90 wt. % of a quartz when fired.

12. The floor tile as recited in claim 1, wherein the main body comprises 2 wt. % to 40 wt. % of calcium aluminosilicate when fired.

13. The floor tile as recited in claim 1, wherein the main body comprises 6 wt. % to 10 wt. % of a fibrous material, 64 wt. % to 72 wt. % of a quartz sand, and 2 wt. % to 40 wt. % of calcium aluminosilicate, when fired.

14. The floor tile as recited in claim 1, wherein the main body further comprises tobermorite.

15. The floor tile as recited in claim 1, wherein the main body is a tobermorite.

16. The floor tile as recited in claim 1, wherein the main body is at least one of chamfered and pressed at all edges.

17. The floor tile as recited in claim 1, wherein the main body further comprises a decorative layer which is arranged on the main body.

18. The floor tile as recited in claim 17, wherein the decorative layer is printed on the main body.

19. The floor tile as recited in claim 17, wherein the main body further comprises a lacquer layer which is arranged on the decorative layer.

20. A process for producing the floor tile as recited in claim 1, the process comprising:
firing the main body; and then
milling the tongue-and-groove joint which is configured to be interlockable into the main body.
